(19) United States
(12) Patent Application Publication
(10) Pub. No.: US 2011/0202596 A1
(43) Pub. Date: Aug. 18, 2011

(54) CACHE SERVER CONTROL DEVICE, CONTENT DISTRIBUTION SYSTEM, METHOD OF DISTRIBUTING CONTENT, AND PROGRAM

(76) Inventor: JUNICHI GOKURAKUJI, Tokyo (JP)

(21) Appl. No.: 13/015,287

(22) Filed: Jan. 27, 2011

(30) Foreign Application Priority Data
Feb. 18, 2010 (JP) 2010-034035

(51) Int. Cl. G06F 15/16

(52) U.S. Cl. 709/203

(57) ABSTRACT

A cache server control device 600 acquires a distribution band, respectively for a plurality of contents to be reproduced. The distribution band herein is the one used for concurrently distributing the same content to be reproduced to the plurality of client terminals 20, when receiving the distribution requests for the same content to be reproduced, respectively from the plurality of client terminals 20. A cache server control device 600 then determines the number of units of cache server necessary for storing the contents to be reproduced, based on the acquired distribution bands, the cache server control device 600 then selects the cache servers 300 necessary for storing the contents to be reproduced, and allows the selected cache servers 300 to store the contents to be reproduced.

This application is based on Japanese patent application No. 2010-034035 the content of which is incorporated hereinto by reference.

### BACKGROUND

1. Technical Field

The present invention relates to a cache server control device which controls cache servers used in a content distribution system, a content distribution system, a method of distributing content, and a program.

2. Background Art

Recently, the speed of data communication network, such as the Internet, has been upgraded. It has also become possible to transmit video contents by high-vision broadcasting with high image quality, by virtue of adoption of H.264/AVC codec. IPTV services may, therefore, be expected to be brought into full operation.

VOD (Video On Demand) service is one of such IPTV services. A content distribution system for realizing the service is configured by a content storage which stores video contents, and a distribution server which distributes the video contents. On the other hand, the content distribution system is required to distribute video contents in a stable manner to a large number of subscribers. A variety of technologies for fulfilling the requirement have been developed.

For example, Japanese Laid-Open Patent Publication No. 2009-182629 discloses a technology of preliminarily allocating to distribution servers, contents which satisfy specific conditions. Japanese Laid-Open Patent Publication No. 2009-165118 discloses a technology of placing the contents in local caches of user terminals before viewing such contents. Japanese Laid-Open Patent Publication No. 2008-072484 discloses a technology of preliminarily predicting a time zone in which loads of the instruments which hold video contents will become heavier in a home area network system, and moving the video contents to other instruments before getting into the time zone.

Japanese Laid-Open Patent Publication No. 2009-033760 discloses a technology of preliminary placing head chunks of the contents in local caches. Japanese Laid-Open Patent Publication No. 2007-080161 discloses a technology of separately holding the full contents and the head portions of the contents, and allowing the clients to concurrently download the full contents and the head portions of the contents.

Japanese Laid-Open Patent Publication No. 2009-237918 discloses a technology of supervising loads of local servers which distribute the contents, and determining the number of contents to be copied to local servers depending on the loads, thereby preparing a copy schedule.

### SUMMARY

As described in the above, it is now possible to transmit contents to be reproduced, such as video contents, through the data communication' network, with high-vision broadcasting with high-quality image. On the other hand, in order to develop the VOD service, it is necessary to distribute not only contents to be reproduced having a format of high-vision broadcasting, but also those already prepared with the conventional image quality. For this reason, it is necessary to configure a content distribution system, so as to concurrently distribute a plurality of contents to be reproduced having different bit rates at the same time.

On the other hand, in order to distribute the contents to be reproduced to the client terminals in a stable manner, it may be preferable to provide cache servers besides distribution servers, and to allow the cache servers to preliminarily store the contents to be reproduced, which cause loads onto the distribution servers. Since conventional contents to be reproduced had a single bit rate, so that it has been good enough to determine which contents to be reproduced should be stored into which cache servers, based on only the number of distribution requests issued for the contents to be reproduced. However, for the case where the contents to be reproduced have different bit rates, even the contents to be reproduced, to which a small number of distribution requests are issued, will heavily load the distribution servers, if such contents to be reproduced have large bit rates. As a consequence, it may be unsuccessful to reduce the loads onto the distribution servers, so far as the contents to be reproduced, to be cached, are determined only based on the number of distribution requests issued for the contents to be reproduced.

It is therefore an object of the present invention to provide a cache server control device, a content distribution system, a method of distributing content, and a program, capable of distributing the contents to be reproduced to the client terminals in a stable manner, even if the contents to be reproduced have different bit rates, by allowing the cache servers to store the content to be reproduced, which cause large distribution loads.

According to the present invention, there is provided a cache server control device which is used for a content distribution system, the content distribution system herein comprising:
a content storage device which stores a plurality of contents to be reproduced, necessary to be distributed to client terminals;
a distribution server which reads the plurality of contents to be reproduced out from the content storage device and distributes them to the client terminals; and
a plurality of cache servers which preliminarily store at least one of the plurality of contents to be reproduced, and distribute it to the client terminals,
   and is configured to judge which of the contents to be reproduced is stored in the cache servers,

wherein the cache server control device comprises:

a distribution band acquisition unit which acquires a distribution band, for when concurrently distributing the contents co be reproduced to the plurality of client terminals in response to a plurality of distribution requests issued for the contents to be reproduced, respectively for the plurality of contents to be reproduced; and

a cache control unit which determines the number of units of cache server necessary for storing the contents to be reproduced, based on the distribution band acquired by the distribution band acquisition unit.

According to the present invention, there is provided a content distribution system which comprises:

a distribution server which reads a plurality of contents to be reproduced out from a content storage device which stores the plurality of contents to be reproduced which are to be distributed to client terminals, and distributes them to the client terminals; a plurality of cache servers which preliminarily store at least one of the plurality of contents to be reproduced, and distribute it to the client terminals; and

a cache server control device configured to judge which of the contents to be reproduced is stored in the cache servers,

wherein the cache server control device comprises:

a distribution band acquisition unit which acquires a distribution band, for when concurrently distributing the contents co be reproduced to the plurality of client terminals in response to a plurality of distribution requests issued for the contents to be reproduced, respectively for the plurality of contents to be reproduced; and

a cache control unit which determines the number of units of cache server necessary for storing the contents to be reproduced, based on the distribution band acquired by the distribution band acquisition unit.

According to the present invention, there is provided a method of distributing comprising the steps of:

allowing a content storage device to preliminarily store a plurality of contents to be reproduced which are to be distributed to client terminals;

allowing a distribution server to read the plurality of contents to be reproduced out from the content storage device, and to distribute them to the client terminals;

allowing a plurality of cache servers to preliminarily store at least one of the plurality of contents to be reproduced, and to send it to the client terminal; and

allowing a cache server control device, configured to judge which of the contents to be reproduced is stored in the cache servers, to acquire a distribution band, for when concurrently distributing the contents to be reproduced to the plurality of client terminals in response to a plurality of distribution requests issued for the contents to be reproduced, respectively for the plurality of contents to be reproduced, and to determine the number of units of cache server necessary for storing the contents to be reproduced, based on the acquired distribution band.

According to the present invention, there is provided a program which is used for a content distribution system, the content distribution system comprising:

a content storage device which stores a plurality of contents to be reproduced, necessary to be distributed to client terminals;

a distribution server which reads the plurality of contents to be reproduced out from the content storage device and distributes them to the client terminals; and

a plurality of cache servers which preliminarily store at least one of the plurality of contents to be reproduced, and distribute it to the client terminals,

wherein the program is configured to allow a computer to realize:

a function of acquiring a distribution band, for when concurrently distributing the contents to be reproduced to the plurality of client terminals in response to a plurality of distribution requests issued for the contents to be reproduced, respectively for the plurality of contents to be reproduced; and

a function of determining the number of units of the cache servers necessary for storing the contents to be reproduced, based on the acquired distribution band.

According to the present invention, even if the contents to be reproduced have different bit rates, the contents to be reproduced may be distributed to the client terminals in a stable manner, by allowing the cache servers to store the contents to be reproduced, which cause large distribution loads.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram illustrating a configuration of a content distribution system according to a first embodiment;

FIG. 2 is a drawing illustrating, in a table form, a data configuration of information stored by a content storage;

FIG. 3 is a drawing illustrating, in a table form, a data configuration of information stored by cache servers;

FIG. 4 is a drawing illustrating, in a table form, a data configuration of information stored by a database;

FIG. 5 is a block diagram illustrating a functional configuration of a cache server control device;

FIG. 6 is a drawing illustrating, in a table form, data stored by a content information storage unit;

FIG. 7 is a drawing illustrating, in a table form, information stored by a load information storage unit;

FIG. 8 is a drawing illustrating a first operation of the content distribution system illustrated in FIG. 1;

FIG. 9 is a drawing illustrating a second operation of the content distribution system illustrated in FIG. 1;

FIG. 10 is a flow chart illustrating details of step S130 in FIG. 9;

FIG. 11 is a drawing illustrating, in a table form, a data configuration of content information storage unit in a second embodiment;

FIG. 12 is a flow chart illustrating processes to be executed when the cache server control device sends a storage command and a deletion command of to a cache server;

FIG. 13 is a flow chart illustrating details of step S130 in FIG. 12; and

FIG. 14 is a drawing specifically explaining the flows illustrated in FIG. 12 and FIG. 13.

### DETAILED DESCRIPTION

The invention will now be described herein with reference to illustrative embodiments. Those skilled in the art will recognize That many alternative embodiments can be accomplished using the teachings of the present invention and That the invention is not limited to the embodiments illustrated for explanatory purposes.

Embodiments of the present invention will be explained referring to the attached drawings. Note that all similar constituents in all drawings will be given similar reference numerals or symbols, so as to occasionally avoid repetitive explanations.

### First Embodiment

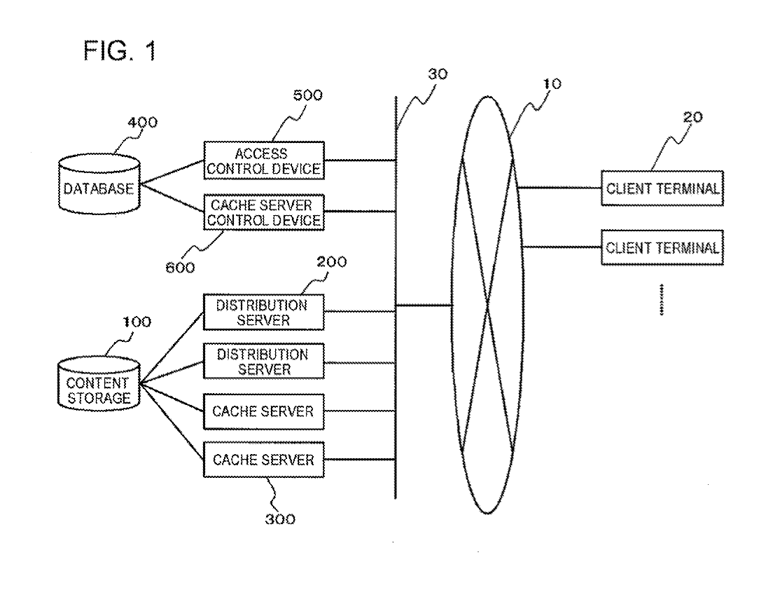

FIG. 1 is a block diagram illustrating a configuration of a content distribution system according to a first embodiment. The content distribution system is a system configured to distribute a plurality of contents to be reproduced, such as video contents and voice contents stored in a content storage device (content storage) 100, through a communication network 10 such as the Internet, to client terminals 20. The contents to be reproduced are assigned with content identification information. The content identification information is used for identifying a plurality of contents to be reproduced from each other.

The content distribution system has, besides the content storage 100, at least one distribution server 200, a plurality of cache servers 300, and a cache server control device 600. The distribution server 200 reads a plurality of contents to be reproduced out from the content storage 100, and distributes them to the client terminals 20. The cache server 300 preliminarily stores (caches) at least one of the plurality of contents to be reproduced, and distributes it to the client terminals 20.

The cache server control device 600 judges which contents to be reproduced should be stored into which cache servers 300. The cache server control device 600 acquires a distribution band, respectively for the plurality of contents to be reproduced. The distribution band is the one used for concurrently distributing the same content to be reproduced to the plurality of client terminals 20, when receiving the distribution requests for the same content to be reproduced, respectively, from the plurality of client terminals 20. The cache server control device 600 then determines the number of units of cache server 300 necessary for storing the contents to be reproduced, based on the thus-acquired distribution band. The cache server control device 600 selects the cache servers 300 necessary for storing the contents to be reproduced, and allows the selected cache servers 300 to store the contents to be reproduced therein.

The content distribution system additionally has a database 400 and an access control device 500. The database 400 stores server specification information, indicating which distribution server 200 or which cache server 300 should distribute which contents to be reproduced, while correlating it with the content identification information. The database 400 is updated by the cache server control device 600.

The access control device 500 receives the distribution requests sent by the client terminals 20 to the content distribution system. The distribution requests are assigned with the content identification information. The access control device 500 reads from the database 400, the server specification information with respect to the content identification information, and sends it to the client terminals 20 which previously sent the distribution requests. The server specification information is typically an URL. When the server specification information is given by an URL, the URL is specified to a depth of hierarchy by which the contents to be reproduced may be specified. Upon reception of the distribution requests for either one of the contents to be reproduced from the client terminals 20, the access control device 500 sends to the cache server control device 600, content identification information of the content to be reproduced, while correlating it with request reception information which indicates reception of the distribution request. As detailed later, the cache server control device 600 acquires the distribution bands, respectively for the contents to be reproduced, by using the request reception information.

Note that the distribution servers 200, the cache servers 300, the access control device 500, and the cache server control device 600 are connected with each other through a communication network 30 such as intranet.

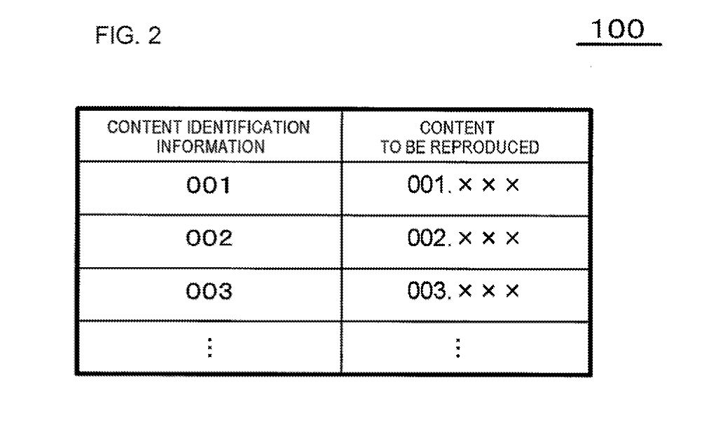

FIG. 2 is a drawing illustrating, in a table form, a data configuration of information stored by the content storage 100. The content storage 100 stores the contents to be reproduced while correlating them with the content identification information. The content storage 100 stores all contents to be reproduced which should be distributed by the content distribution system illustrated in FIG. 1.

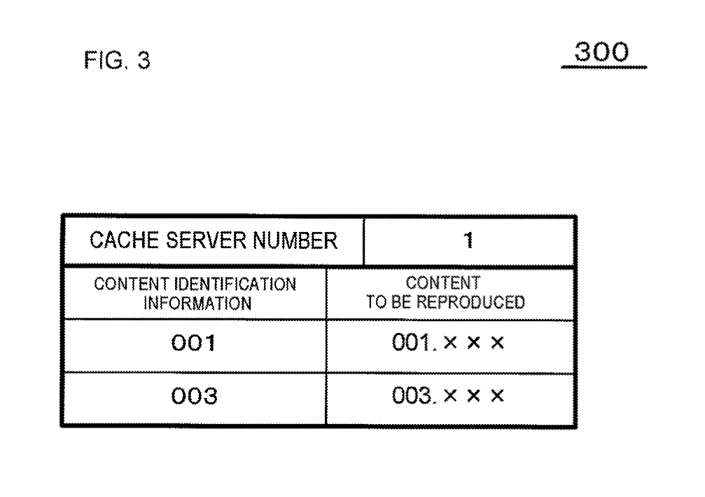

FIG. 3 is a drawing illustrating, in a table form, a data configuration of information stored by the cache servers 300. Each cache server 300 is assigned with a cache server number, as cache server identification information used for identifying a plurality of cache servers 300 from each other. The cache servers 300 store the contents to be reproduced to which a large number of distribution requests are issued, while correlating them with the content identification information. The contents to be reproduced stored by the cache servers 300 are different from cache server 300 to cache server 300. For the case where the server specification information is given by an URL, the cache server 300 stores the contents to be reproduced while correlating them with the URL. The URL is specified to with respect to each of the contents to be reproduced.

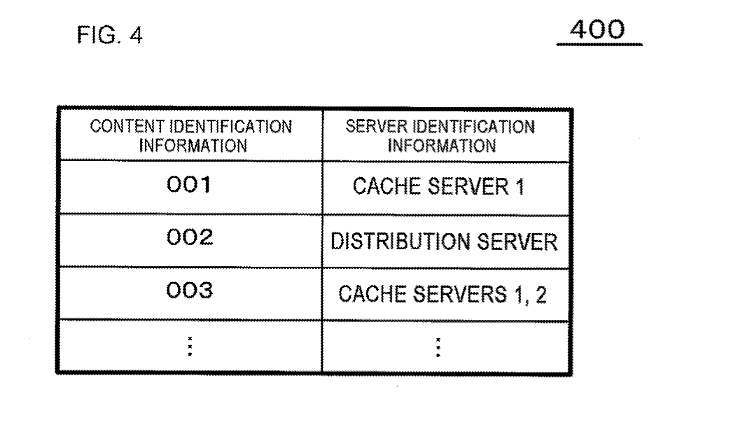

FIG. 4 is a drawing illustrating, in a table form, a data configuration of information stored by the database 400.

The database 400 stores the content identification information, while correlating it with the server specification information, indicating that from which server the contents to be reproduced are distributed, such as cache server numbers, respectively, for contents to be reproduced.

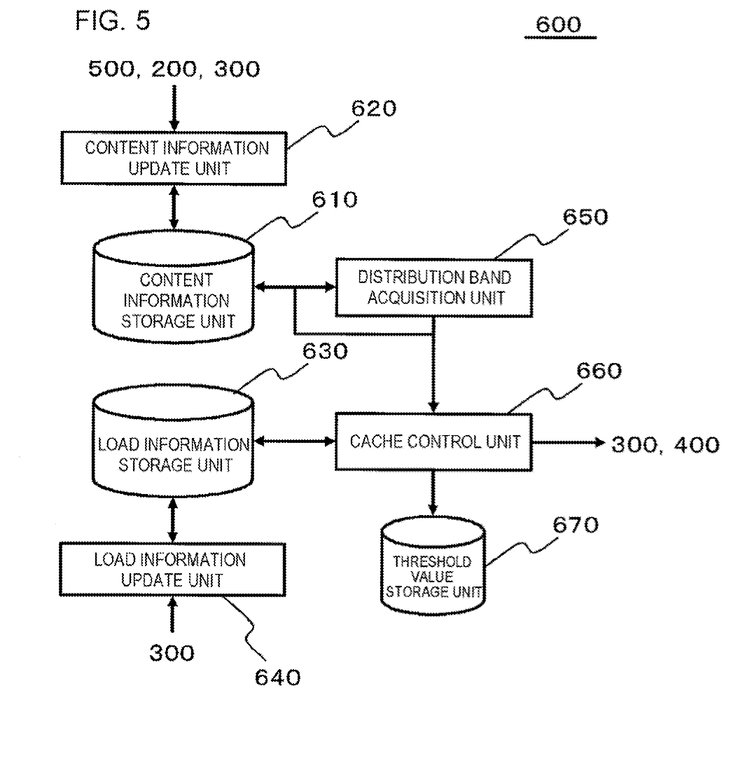

FIG. 5 is a block diagram illustrating a functional configuration of the cache server control device 600. The cache server control device 600 has a distribution band acquisition unit 650 and a cache control unit 660. The distribution band acquisition unit 650 acquires a distribution band, respectively for the plurality of contents to be reproduced. The distribution band is the one used for concurrently distributing the same content to be reproduced to the plurality of client terminals 20, when receiving the distribution requests for The same content to be reproduced, from the plurality of client terminals 20, respectively. The cache control unit 660 then determines the number of units of cache server 300 necessary for storing the contents to be reproduced, based on the distribution bands acquired by the distribution band acquisition unit 650. The number of units determined herein can be zero for some cases.

The cache server control device 600 additionally has a content information storage unit 610, a content information update unit 620, a load information storage unit 630, a load information update unit 640, and a threshold value storage unit 670.

The content information storage unit 610 stores the cache information which indicates which contents to be reproduced are stored in which cache servers 300, respectively for the plurality of contents to be reproduced. The content information storage unit 610 also serves as a bit rate storage unit and a distribution request storage unit. More specifically, the content information storage unit 610 stores bit rates of the content to be reproduced and currently-valid number of distribution requests, while correlating them with the contents identification information, respectively for the plurality of contents to be reproduced. The distribution band provided respectively for The contents to be reproduced may be calculated by multiplying the bit rate and the number of distribution requests. The distribution band is calculated typically by the content information update unit 620.

Upon reception of the request reception information and the content identification information from the access control device 500, the content information update unit 620 updates the information stored by the content information storage unit 610. More specifically, upon reception of the request reception information and the content identification information from the access control device 500, the content information update unit 620 increases the number of distribution requests corresponding to the received content identification information by one.

The content information update unit 620 also receives distribution end information, which indicates that the distribution of the contents to be reproduced ended, from the distribution servers 200 or the cache servers 300, while correlating them with the content identification information of the contents to be reproduced. The content information update unit 620 then updates the content information storage unit 610, and decreases the number of distribution requests corresponding to the received content identification information by one.

The load information storage unit 630 stores load information which indicates loads of the cache servers, respectively for the plurality of cache servers 300. The load information update unit 640 periodically acquires information which indicates distribution loads (distribution bands, for example) of the cache servers 300, respectively from the plurality of cache servers 300, and periodically updates the load information storage unit 630 by using the thus-acquired information.

The threshold value storage unit 670 stores threshold values of the distribution bands. The threshold values are used when the cache control unit 660 determines the number of units of cache server 300, respectively for the contents to be reproduced.

Note that FIG. 5 does not illustrate portions which are not essential to the present invention. The individual constituents of the cache server control device 600 illustrated in FIG. 5 are expressed on the basis of functional blocks, rather than on the hardware basis. The individual constituents of the cache server control device 600 are realized by arbitrary combinations of hardware and software, represented by CPU of arbitrary computer, memory, program for realizing the constituents of the present invention loaded in the memory, storage unit such as hard disk for storing the program, and interface for networking.

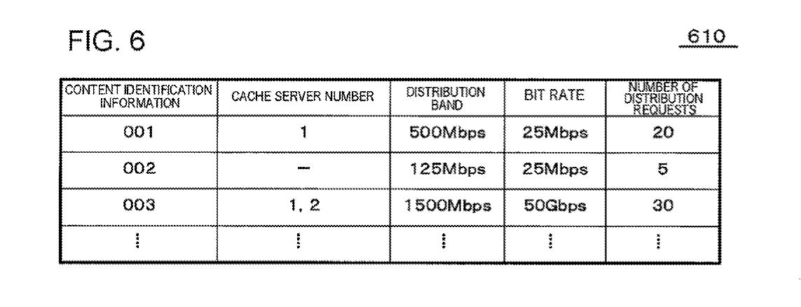

FIG. 6 is a drawing illustrating, in a table form, data stored by the content information storage unit 610 of the cache server control device 600. The content information storage unit 610 stores the content identification information, cache server numbers of the cache servers 300 which store the contents to be reproduced, distribution bands, bit rates, and the number of distribution requests, respectively for the contents to be reproduced. The distribution bands are given as values obtained by multiplying the bit rates and the number of distribution requests.

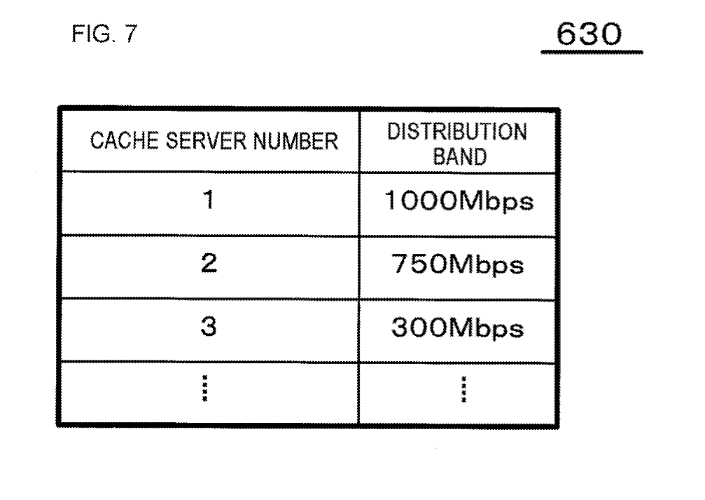

FIG. 7 is a drawing illustrating, in a table form, information stored by the load information storage unit 630. The load information storage unit 630 stores the cache server numbers, and the distribution bands which indicate the loads of the cache servers 300 in a mutually correlated manner, respectively for the plurality of cache servers 300.

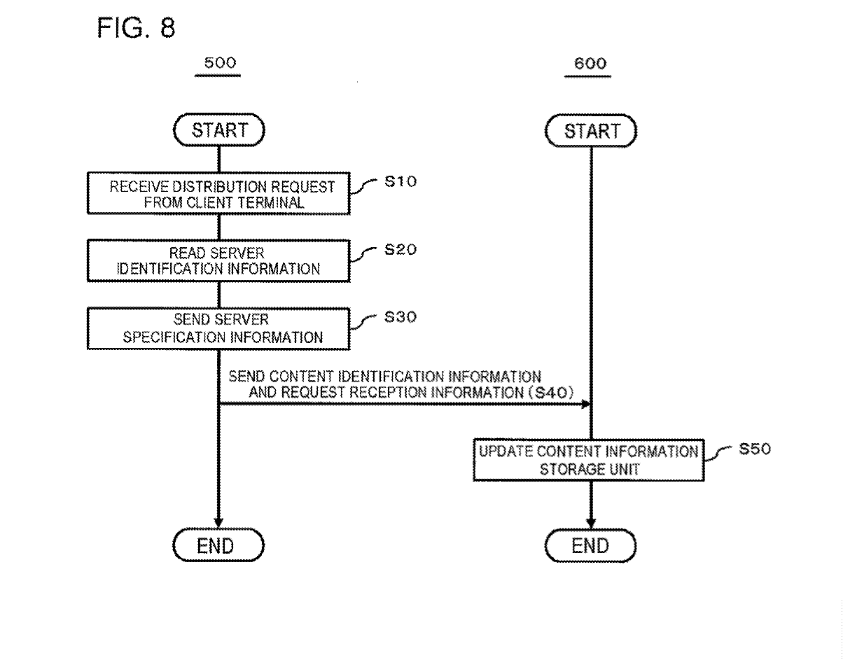

FIG. 8 is a drawing illustrating a first operation of the content distribution system illustrated in FIG. 1. The operation represents the one to be executed upon reception of the distribution requests of contents from the client terminals 20.

Each client terminal 20 sends the distribution request of the content to The access control device 500, while correlating it with the content identification information. Upon reception of the distribution request and the content identification information (step S10), the access control device 500 reads the server specification information, corresponding to the received content identification information, out from the database 400 (step S20), and then sends the thus-read server specification information to the client terminal 20 (step S30).

While not illustrated in the drawing, upon reception of the server specification information from the access control device 500, the client terminal 20 makes an access to the distribution server 200 or the cache server 300 by using the thus-received server specification information. The accessed distribution server 200 or the cache server 300 starts distribution of the content to be reproduced to the client terminal 20.

After sending the server specification information to the client terminal 20, the access control device 500 sends the content identification information received in step S10 to the cache server control device 600, while correlating it with the request reception information (step S40). Upon reception of the content identification information and the request reception information from the access control device 500, the content information update unit 620 of the cache server control device 600 updates the content information storage unit 610, and increases the number of distribution requests corresponding to the received content identification information by one (step S50).

Upon completion of the distribution of the content to be reproduced to the client terminal 20, the distribution server 200 or the cache server 300 sends the distribution end information to the cache server control device 600, while correlating it with the content identification information of the content to be reproduced. Upon reception of the distribution end information from the distribution server 200 or the cache server 300, in a form correlated with the content identification information, the content information update unit 620 of the cache server control device 600 updates the content information storage unit 610, and decreases the number of distribution requests corresponding to the received content identification information by one.

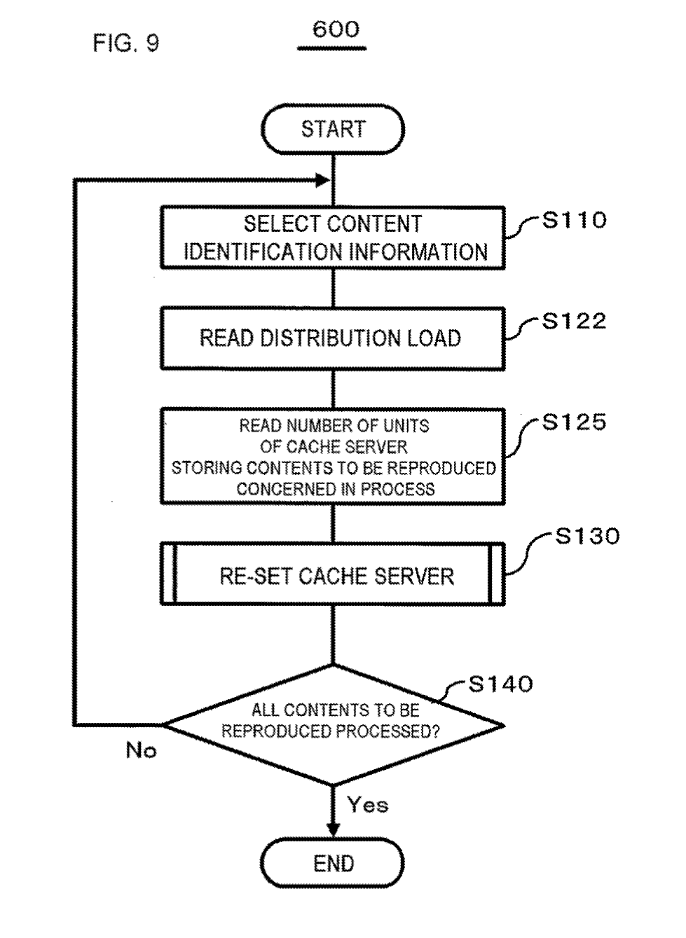

FIG. 9 is a drawing illustrating a second operation of the content distribution system illustrated FIG. 1. The operation is the one executed by the cache server control device 600, when modifying setting of the cache servers 300. The processes illustrated in this drawing are periodically executed.

The distribution band acquisition unit 650 of the cache server control device 600 selects one content identification information (step S110). The distribution band acquisition unit 650 reads the distribution band corresponding to the selected content identification information, out from the content information storage unit 610 (step S122). The distribution band acquisition unit 650 also reads out from the content information storage unit 610, the current number of units of cache server 300 which store the content to be reproduced corresponding to the selected content identification information, (step S125). The number of units is determined typically based on how many cache server numbers are stored with respect to the selected content identification information in the content information storage unit 610.

Next, the distribution band acquisition unit 650 outputs the thus-read distribution band and the number of units of cache server 300 to the cache control unit 660, while correlating it with the content identification information. The cache control unit 660 re-sets the cache servers 300 by using the information received from The distribution band acquisition unit 650 (step S130).

The distribution band acquisition unit 650 and the cache control unit 660 repeat all processes from step S110 to step S130, for all of the content identification information (step S140).

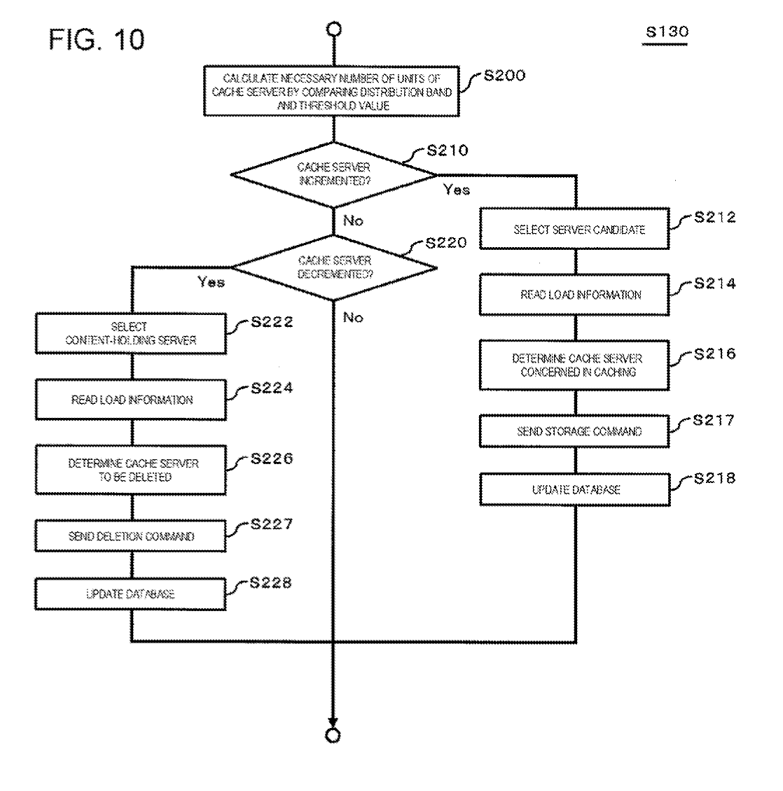

FIG. 10 is a flow chart illustrating details of the processes in step S130 in FIG. 9, that is, the re-setting processes of the cache servers 300 executed by the cache control unit 660. The cache control unit 660 reads one of threshold values of the distribution band from the threshold value storage unit 670. The threshold value is set in a multi-level manner. More specifically, the threshold value storage unit 670 stores a certain reference value and a constant. Values obtained by adding the constant to each of integer multiples of the reference value are used as the threshold value.

First, the cache control unit 660 compares the distribution band acquired from the distribution band acquisition unit 650 with the threshold value read out from the threshold value storage unit 670, and determines a necessary number of units of cache server 300, by judging which level of the threshold value the distribution band exceeds. More specifically, the cache control unit 660 calculates a necessary number of units of cache server 300, by subtracting the constant from the distribution band, dividing such a difference by the reference value, and omitting decimals from the quotient calculated therefrom (step S200).

The cache control unit 660 judges whether the number of units of cache server 300 calculated in step S200 exceeds the current number of units of cache server 300 acquired from the distribution band acquisition unit 650, or not (step S210). If exceeding (step S210: Yes), the cache control unit 660 reads the cache server number corresponding to the content identification information acquired from the distribution band acquisition unit 650, out from the content information storage unit 610. The cache control unit 660 then selects the cache servers 300 assigned with numbers other than the thus-read cache server number, that is, the cache servers 300 which do not store the contents to be reproduced related to the judgment, as server candidates (step S212).

Next, the cache control unit 660 recognizes the cache server numbers of the server candidates, and reads the load information (or distribution bands) corresponding to the recognized cache server numbers out from the load information storage unit 630 (step S214). The cache control unit 660 also recognizes the difference between the number of units of cache server 300 calculated in step S200 and the current number of units, as the number of units of cache server 300 to be added. The cache control unit 660 then recognizes loads on the individual server candidates by using the thus-read load information, and selects a necessary number of units of the server candidates in an increasing order of load. In this way, the cache servers 300, required to cache the content to be reproduced related to the processing, are determined (step S216).

Next, the cache control unit 660 sends the content identification information, acquired from the distribution band acquisition unit 650, to the cache servers 300 having cache server numbers selected in step S216, together with a storage command which asks the cache servers 300 to read out from the content storage 10, the contents to be reproduced corresponding to the content identification information, and to store such contents (step S217). Upon reception of the storage command while being correlated with the content identification information, the cache servers 300 read the contents to be reproduced corresponding to the received content identification information, out from the content storage 100.

The cache control unit 660 updates the database 400, and adds the cache server numbers of the cache servers 300 determined in step S216, to the cache server numbers corresponding to the content identification information acquired from the distribution band acquisition unit 650 (step S218).

On the other hand, if the necessary number of units of cache server 300 calculated in step S200 is not found to exceed the current number of units of cache server 300 (step S210: No), the cache control unit 660 judges whether the necessary number of units conversely reduces or not (step S220). If reducing (step S220: Yes), the cache control unit 660 reads out from the content information storage unit 610, the cache server numbers corresponding to the content identification information acquired from the distribution band acquisition unit 650. The cache control unit 660 then selects the cache servers 300 assigned with the thus-read cache server numbers, that is, the cache servers 300 currently storing the contents to be reproduced related to the judgment, as content storing servers (step S222).

Next, the cache control unit 660 recognizes the cache server numbers of the content-storing servers, and reads the load information (or distribution bands) corresponding to the thus-recognized cache server numbers, out from the load information storage unit 630 (step S224). On the ocher hand, the cache control unit 660 recognizes the difference between the number of units of cache server 300 calculated in step S200 and the current number of units, as the number of units of cache server 300 from which the contents to be reproduced are deleted. The cache control unit 660 then recognizes loads of the individual storing by using the thus-read load information, and selects a necessary number of units of the storing servers in a decreasing order of load. In this way, the cache servers 300, from which the contents to be reproduced related to the processing should be deleted, are determined (step S226).

Next, the cache control unit 660 sends the content identification information acquired from the distribution band acquisition unit 650, to the cache servers 300 having the cache server numbers selected in step S226, together with a deletion command which asks the cache servers 300 to delete the contents to be reproduced corresponding to the content identification information (step S227). Upon reception of the deletion command while being correlated with the content identification information, the cache servers 300 delete the contents to be reproduced corresponding to the received content identification information.

The cache control unit 660 then updates the database 400, and deletes the cache server numbers of the cache servers 300 determined in step S226, from the cache server numbers stored in the database 400, corresponding to the content identification information acquired from the distribution band acquisition unit 650 (step S228).

Next, operations and effects of this embodiment will be explained. According to this embodiment, the cache control unit 660 of the cache server control device 600 acquires the distribution bands, respectively for the contents to be reproduced and increases the number of units of cache server 300 necessary for caching the contents to be reproduced, if the acquired distribution bands were found to exceed the reference value. As a consequence, since the content distribution system may allow the cache servers 300 to store the contents to be reproduced, causing large distribution loads, even for the case where the bit rates are different depending on the contents to be reproduced, so that the contents to be reproduced may be distributed to the client terminals 20 in a stable manner.

The content information storage unit 610 of the cache server control device 600 stores the bit rates of the contents to be reproduced and the number of distribution requests of the contents to be reproduced, while correlating them with the content identification information, respectively for the plurality of contents to be reproduced. Accordingly, the cache server control device 600 may readily acquire the distribution bands, respectively for the contents to be reproduced. Note that he cache server control device 600 preliminarily acquires the number of reproduction requests of the contents to be reproduced from the access control device 500. The number of distribution requests and the distribution bands may therefore be kept always at latest values.

In the cache server control device 600, the threshold value of the distribution band is set in a multi-level manner. Accordingly, the cache server control device 600 may readily determine the necessary number of units of cache server 300, by judging which level of the threshold value the distribution band exceeds.

In the process of increasing the number of units of cache server 300 for caching certain content to be reproduced, the cache control unit 660 of the cache server control device 600 selects the cache servers 300 in an increasing order of load. Such loads may therefore be prevented from concentrating on specific cache servers 300.

On the other hand, in the process of decreasing the number of units of cache server 300 for caching certain content to be reproduced, the cache control unit 660 of the cache server control device 600 selects the cache servers 300 in a decreasing order of load. Accordingly, such loads may further be prevented from concentrating on specific cache servers 300.

### Second Embodiment

A content distribution system of a second embodiment is similar to the content distribution system of the first embodiment, except for processes of the cache server control device 600 executed, when sending the storage command and the deletion command to the cache servers 300.

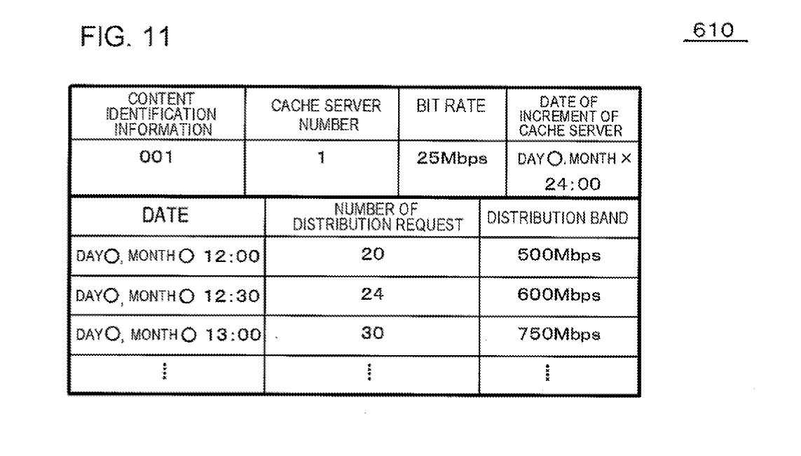

FIG. 11 is a drawing illustrating, in a table form, a data configuration of the content information storage unit 610 of the cache server control device 600 according to this embodiment. In this embodiment, the content information storage unit 610 stores history information of the distribution bands, respectively for the contents to be reproduced. More specifically, the content information storage unit 610 stores content identification information, cache server numbers, bit rates, and distribution bands as the history information, respectively for the contents to be reproduced. The history information of the distribution bands is typically composed of the number of distribution requests and the distribution bands at certain date and time, while being correlated with such date-and-time information.

The content information storage unit 610 also stores the latest date and time at which the number of units of cache server 300 storing the contents to be reproduced were increased, respectively for the contents to be reproduced.

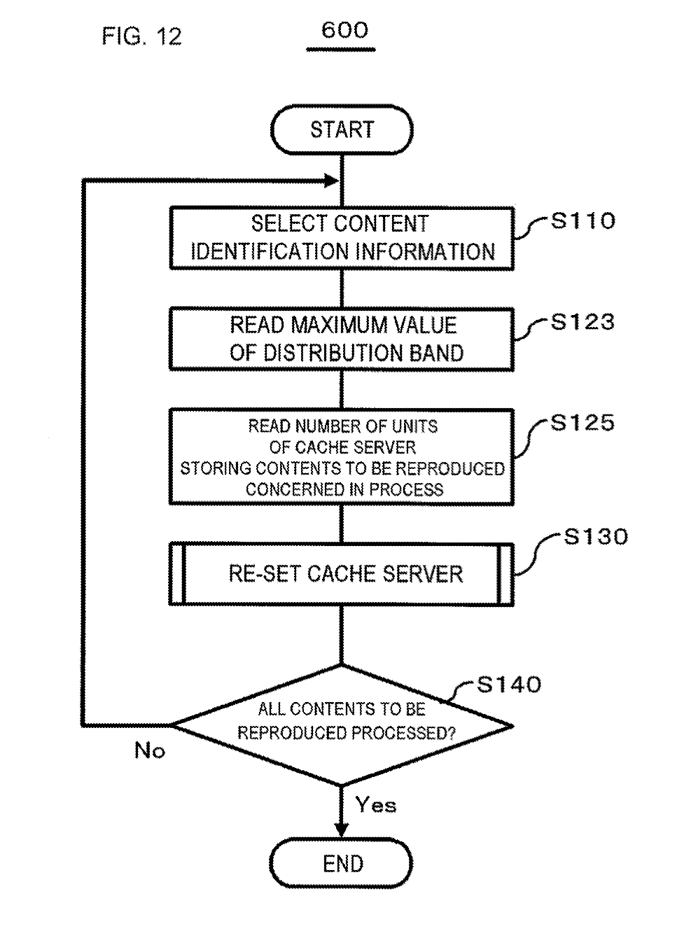

FIG. 12 is a flow chart illustrating processes executed when the cache server control device 600 sends the storage command and the deletion command to the cache servers 300. Processes in the flow chart illustrated herein are similar to those previously explained referring to FIG. 9 in the first embodiment, except for the following points.

First, in the process of reading the distribution bands out from the content information storage unit 610, provided-respectively for the contents to be reproduced, the distribution band acquisition unit 650 of the cache server control device 600 reads the maximum values of the distribution bands found in every check period, each of which is defined by a predetermined length of time, based on such a predetermined check period basis (step S123). The process is executed by using the history information of the distribution bands. Each of the check period is typically defined by an integer multiple of 24 hours.

Another difference may be found in details of the re-setting process of the cache servers 300 (step S130).

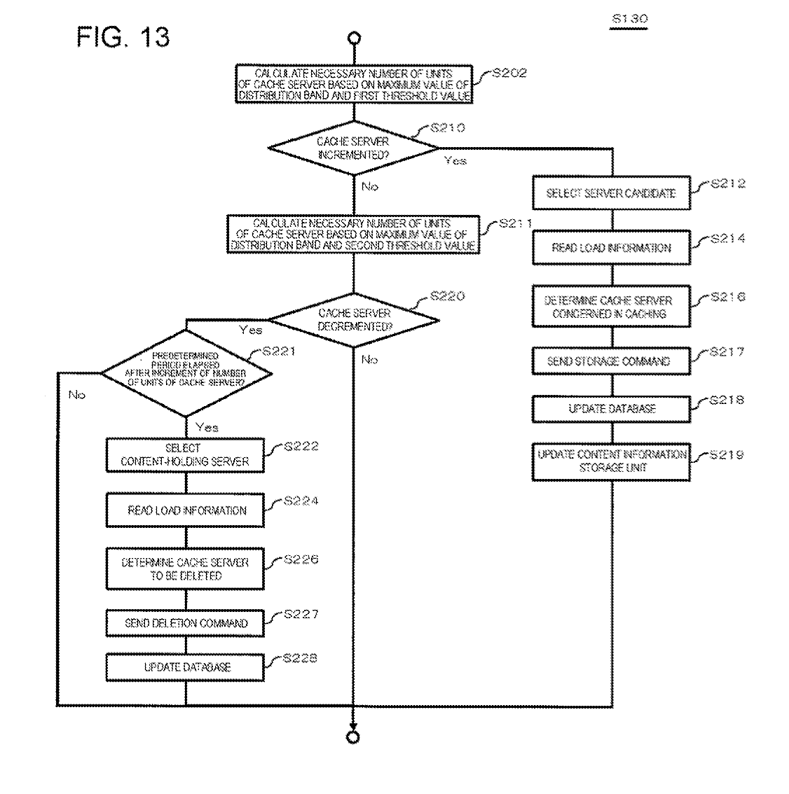

FIG. 13 is a flow chart illustrating details of step S130 in FIG. 12. In the process illustrated in the flow chart, the cache control unit 660 of the cache server control device 600 uses a first threshold value, when the number of units of cache server 300 for storing the content to be reproduced related to the judgment is increased. On the other hand, the cache control unit 660 uses a second threshold value, having a smaller value than that of the first threshold value, when the number of units of cache server 300 for storing the content to be reproduced related to the judgment is decreased. The information determining the first threshold value and the second threshold value is preliminarily stored in the threshold value storage unit 670.

First, the cache control unit 660 determines a necessary number of units of cache server 300, by comparing the maximum value of the distribution band acquired from the distribution band acquisition unit 650 with the first threshold value read out from the threshold value storage unit 670, and judging which level of the threshold value the distribution band exceeds. More specifically, the cache control unit 660 calculates a necessary number of units of cache server 300, by subtracting a constant from the maximum value of the distribution band, dividing such a difference by the reference value, and omitting decimals from the quotient calculated therefrom (step S202).

The cache control unit 660 then judges whether the necessary number of units of cache server 300 calculated in step S202 exceeds the current number of units of cache server 300 acquired from the distribution band acquisition unit 650 (step S210). If exceeding—(step S210: Yes), the cache control unit 660 executes processes in step S212 to step S218. The processes executed herein are the same as those explained in the first embodiment referring to FIG. 10. The cache control unit 660 then updates, in the content information storage unit 610, the latest date on which the number of the units of cache servers 300 was increased, among information corresponding to the content identification information acquired from the distribution band acquisition unit 650, into the current date (step S219).

On the other hand, for the case where the necessary number of units of cache server 300 calculated in step S202 was found to be smaller than the current number of units of cache server (step S210: No), the cache control unit 660 compares the maximum value of the distribution band acquired from the distribution band acquisition unit 650 with the second threshold value. The cache control unit 660 then judges which level of the second threshold value the distribution band exceeds, thereby setting a necessary number of units of cache server 300. The second threshold value of each level is determined typically by subtracting a constant from the first threshold value of each level (step S211). The cache control unit 660 then judges whether the necessary number of units of cache server 300 calculated in step S211 is smaller than the current number of units of cache server 300 acquired from the distribution band acquisition unit 650 (step S220).

If it was found to be smaller (step S220: Yes), the cache control unit 660 reads out from the content information storage unit 610, the latest date on which the number of units of cache server 300 was increased, among information corresponding to the content identification information acquired from the distribution band acquisition unit 650. If a predetermined period has not elapsed from the thus-read date (step S221: No), the number of units of cache server 300 is not decreased. On the other hand, if the predetermined period has elapsed from the thus-read date (step S221: Yes), the processes in step S222 to step S228 are executed. The processes executed herein are similar to those explained in the first embodiment referring to FIG. 10.

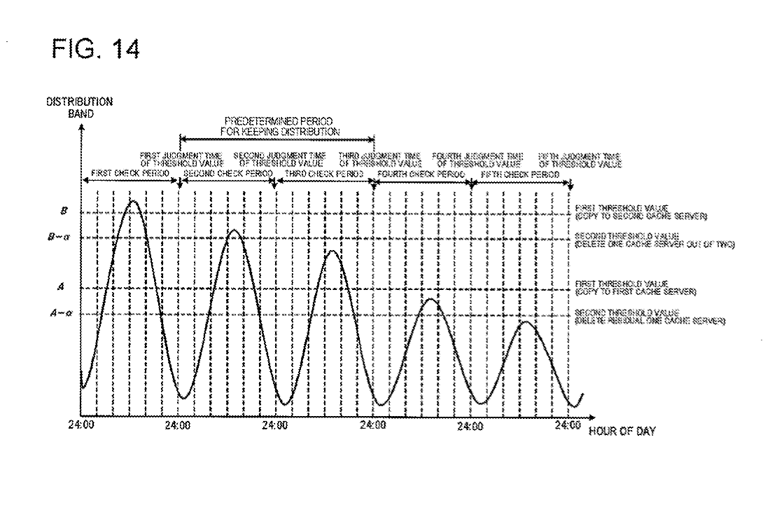

FIG. 14 is a drawing for specifically explaining the flows illustrated in FIG. 12 and FIG. 13. In the drawing, the first threshold value is set to level A, and to level B higher than level A. Level A is a threshold value for judging whether the content to be reproduced should be stored (copied) in a first cache server 300, and level B is a threshold value for judging whether the content to be reproduced should be stored (copied) in a second cache server 300.

The second threshold value is set to level A-α and level B-α. Level B-α is a threshold value for judging whether the content to be reproduced should be deleted from one of two cache servers 300, and level A-α is a threshold value for judging whether the content to be reproduced should be deleted from the remaining one cache server 300.

The check period explained referring to in FIG. 12 is given as 24 hours in FIG. 14. The content distribution system executes the processes shown in FIG. 12 and FIG. 13 at 24:00 everyday. In an exemplary case illustrated in FIG. 14, in a first check period, the maximum value of the distribution band of the content to be reproduced exceeds level B. Accordingly, at the time of judging the threshold value immediately after the first check period, the cache control unit 660 of The cache server control device 600 increases the number of units of cache server 300, to which the content to be reproduced is copied (cached), by two (step S210, and S212 to S218).

Thereafter, the distribution band of the content to be reproduced gradually decreases, and the maximum value thereof falls below level B-α in the third check period. However, in the exemplary case illustrated in this drawing, the number of units of cache server 300 is set so as not to be decreased for 48 hours once increased. Accordingly, at the third judgment time of the threshold value, the cache control unit 660 does not execute the process for decreasing the number of units of cache server 300 (step S221: No in FIG. 13).

Also in the following fourth check period, the maximum value of the distribution band of the content to be reproduced still falls below level B-α. The maximum value of the distribution band falls even below level A, but remains higher than level A-α. Accordingly, in the fourth judgment time of threshold value, the cache control unit 660 executes processes of decreasing the number of units of cache server 300 to one, but not to zero (step S222 to step S228 in FIG. 13).

In the following fifth check period, the maximum value of the distribution band of the content to be reproduced falls below level A-α. Accordingly, in the fifth judgment time of threshold value, the cache control unit 660 executes processes of decreasing the number of units of cache server 300 to zero (step S221 to step S228 in FIG. 13).

Next, the operations and effects of this embodiment will be explained. Principally, the effects similar to those in the first embodiment may be obtained also by this embodiment.

In some cases, the distribution band of the content to be reproduced may be kept at almost constant level while repeating slight increase and decrease. In such case, if the same threshold value are used for increase and decrease of the number of units of cache server 300, the increase and decrease of the number of units of cache server 300 may otherwise be repeated again and again. In contrast, according to this embodiment, the second threshold value for judging that the number of units of, cache server 300 is decreased is set to be smaller than the first threshold value for judging that the number of units of cache server 300 is decreased. Accordingly, the number of units of cache server 300 may be prevented from repetitively increasing and decreasing, even if the distribution band is kept at almost constant level while repeating slight increase and decrease.

The increase and decrease of the distribution band of the content to be reproduced tend to repeat every predetermined period, and typically every 24 hours. Accordingly, a possibility that the maximum value of load applied to the distribution servers 200 exceeds an allowable value may be suppressed, by calculating the maximum value of the distribution band every predetermined period (check period), and by comparing such a maximum value with the threshold values, to thereby determine the number of units of cache server 300, just like in this embodiment.

The content to be reproduced, which was necessary to increase the number of units of cache server 300 in a certain check period, is very likely to keep at a high level in terms of the number of distribution requests. Nevertheless, for some reason, there may be a case where the number of distribution requests may temporarily decrease. However, in this case, a process may be executed such as decreasing the number of units of cache server 300, upon temporary decrease in the number of distribution requests, and then increasing the number of units of cache server 300 immediately thereafter. In contrast, he cache control unit 660 in this embodiment does no execute the processes for decreasing the number of units of cache server 300, for a predetermined period after increasing the number of units of cache server 300. Accordingly, the number of units of cache server 300 may be prevented from being increased or decreased so often, due to execution of the above-described processes.

The embodiments of the present invention have been described referring to the attached drawings merely for exemplary purposes, while allowing adoption of various configurations other than those described in the above.

It is apparent that the present invention is not limited to the above embodiments, that may be modified and changed without departing from the scope and spirit of the invention.

What is claimed is:

1. A cache server control device which is used for a content distribution system,
said content distribution system comprising:
a content storage device which stores a plurality of contents to be reproduced, necessary to be distributed to client terminals;
a distribution server which reads said plurality of contents to be reproduced out from said content storage device and distributes them to said client terminals; and
a plurality of cache servers which preliminarily store at least one of said plurality of contents to be reproduced, and distribute it to said client terminals,
and is configured to judge which of said contents to be reproduced is stored in said cache servers,
wherein said cache server control device comprises:
a distribution band acquisition unit which acquires a distribution band, for when concurrently distributing said contents to be reproduced to said plurality of client terminals in response to a plurality of distribution requests issued for said contents to be reproduced, respectively for said plurality of contents to be reproduced; and
a cache control unit which determines the number of units of said cache servers necessary for storing said contents to be reproduced, based on said distribution band acquired by said distribution band acquisition unit.

2. The cache server control device according to claim 1,
wherein said plurality of contents to be reproduced are preliminarily assigned with content identification information for identifying them from each other,
said cache server control device further comprising:
a bit rate storage unit which stores bit rates of said contents to be reproduced, while correlating them with said content identification information, respectively for said plurality of contents to be reproduced; and
a number-of-distribution-request storage unit which stores numbers of distribution requests issued for said contents to be reproduced, while correlating them with said content identification information, respectively for said plurality of contents to be reproduced, and
said distribution band is calculated based on said bit rate stored in said bit rate storage unit, and said number of distribution requests stored in said number-of-distribution-request storage unit.

3. The cache server control device according to claim 2,
wherein said content distribution system further comprises:
an access control device which receives, from said client terminals, any one of distribution requests issued for said contents to be reproduced, and sends back to said client terminals, server specification information which specifies said distribution servers or said cache servers for distributing said contents to be reproduced; and
said number-of-distribution-request storage unit receives information which indicates reception of said distribution request from said access control device, while correlating it with said content identification information, and increases said number of distribution requests corresponding to said received content identification information.

4. The cache server control device according to claim 1,
wherein said distribution band has a threshold value preliminarily determined in a multi-level manner, and
said cache control unit judges which level of said threshold value said distribution band exceeds, and determines the number of units of said cache servers based on the judgment.

5. The cache server control device according to claim 1, further comprising:
a load information storage unit which stores load of said cache servers, respectively for said plurality of cache servers; and
a content information storage unit which stores cache information which indicates in which cache servers said contents to be reproduced are stored, respectively for said plurality of cache servers,
wherein said cache control unit increases the number of units of said cache servers for storing said contents to be reproduced related to the judgment by:
selecting said cache servers not storing said contents to be reproduced related to the judgment, as server candidates, based on said cache information, and
recognizing load of said server candidates respectively, by using said load information, selecting a necessary number of units of said server candidates in increasing order of load, and allowing such server candidates to store said contents to be reproduced related to the processing.

6. The cache server control device according to claim 1, further comprising:
a load information storage unit which stores load information indicating load of said cache servers, respectively for said plurality of cache servers; and
a content information storage unit which stores cache information which indicates in which cache servers said contents to be reproduced are stored, respectively for said plurality of contents to be reproduced,
wherein said cache control unit decreases the number of units of said cache servers for storing said contents to be reproduced related to the judgment by:
selecting said cache servers for storing said contents to be reproduced related to the judgment, as content storing servers, based on said cache information, and
recognizing load of said content storing servers by using said load information, respectively, selecting a necessary number of units of said content storing servers in decreasing order of load, thereby allowing such content servers to delete said contents to be reproduced related to the processing.

7. The cache server control device according to claim 4,
wherein the number of units of said cache servers, for storing said content to be reproduced related to the judgment, is increased by referring to a first threshold value, and
the number of units of said cache servers, for storing said content to be reproduced related to the judgment, is decreased by referring to a second threshold value, being lower than said first threshold value.

8. The cache server control device according to claim 1,
wherein said distribution band acquisition unit acquires, in every check period preliminarily determined, a maximum value of said distribution band in said check period, respectively for said contents to be reproduced, and
said cache control unit determines the number of units of said cache server necessary for storing said contents to be reproduced, based on the maximum value of said distribution band.

9. The cache server control device according to claim 1,
wherein, for the case where the number of units of said cache servers which store one of said contents to be reproduced is increased,
said cache control unit does not execute a process for decreasing the number of units of said cache servers which store said one of said contents to be reproduced, for a predetermined period.

10. A content distribution system comprising:
a distribution server which reads a plurality of contents to be reproduced out, from a content storage device which stores said plurality of contents to be reproduced which are to be distributed to client terminals, and distributes them to said client terminals;
a plurality of cache servers which preliminarily store at least one of said plurality of contents to be reproduced, and distribute it to said client terminals; and
a cache server control device configured to judge which of said contents to be reproduced is stored in said cache servers,
wherein said cache server control device comprises:
a distribution band acquisition unit which acquires a distribution band, for when concurrently distributing said contents to be reproduced to said plurality of client terminals in response to a plurality of distribution requests issued for said contents to be reproduced, respectively for said plurality of contents to be reproduced; and
a cache control unit which determines the number of units of said cache servers necessary for storing said contents to be reproduced, based on said distribution band acquired by said distribution band acquisition unit.

11. The content distribution system according to claim 10,
wherein said plurality of contents to be reproduced are preliminarily assigned with content identification information for identifying them from each other,
said cache server control device further comprising:
a bit rate storage unit which stores bit rates of said contents to be reproduced, while correlating them with said content identification information, respectively for said plurality of contents to be reproduced; and
a number-of-distribution-request storage unit which stores numbers of distribution requests issued for said contents to be reproduced, while correlating them with said content identification information, respectively for said plurality of contents to be reproduced, and
said distribution band acquisition unit of said cache server control device calculates said distribution band, based on said bit rate stored in said bit rate storage unit, and said number of distribution requests stored in said number-of-distribution-request storage unit, respectively for said plurality of contents to be reproduced.

12. The content distribution system according to claim 11, further comprising:
an access control device which receives, from said client terminals, any one of distribution requests issued for said contents to be reproduced, and sends server specification information which specifies said distribution servers or said cache servers for distributing said contents to be reproduced, back to said client terminals,
upon reception of said distribution request of any one of said contents to be reproduced from said client terminals, said access control device sends said content identification information of said content to be reproduced, while correlating it with a request reception information which indicates reception of said distribution request, to said cache server control device, and
upon reception of said request reception information and said content identification information from said access control device, said number-of-distribution-request storage unit of said cache server control device increases said number of distribution request corresponding to said received content identification information.

13. A method of distributing content comprising:
allowing a content storage device to preliminarily store a plurality of contents to be reproduced which are to be distributed to client terminals;
allowing a distribution server to read said plurality of contents to be reproduced from said content storage device, and to distribute them to said client terminals;
allowing a plurality of cache servers to preliminarily store at least one of said plurality of contents to be reproduced, and to send it to said client terminal; and
allowing a cache server control device, configured to judge which of said contents to be reproduced is stored in said cache servers, to acquire a distribution band, for when concurrently distributing said contents to be reproduced to said plurality of client terminals in response to a plurality of distribution requests issued for said contents to be reproduced, respectively for said plurality of contents to be reproduced, and to determine the number of units of said cache servers necessary for storing said contents to be reproduced, based on said acquired distribution band.

14. A program which is used for a content distribution system, said content distribution system comprising:
a content storage device which stores a plurality of contents to be reproduced, necessary to be distributed to client terminals;
a distribution server which reads said plurality of contents to be reproduced out from said content storage device and distributes them to said client terminals; and
a plurality of cache servers which preliminarily store at least one of said plurality of contents to be reproduced, and distribute it to said client terminals,
wherein the program is configured to allow a computer to realize:
a function of acquiring a distribution band, for when concurrently distributing said contents to be reproduced to said plurality of client terminals in response to a plurality of distribution requests issued for said contents to be reproduced, respectively for said plurality of contents to be reproduced; and
a function of determining the number of units of said cache servers necessary for storing said contents to be reproduced, based on said acquired distribution band.
